(19) United States
(12) Patent Application Publication
(10) Pub. No.: US 2009/0012250 A1
(43) Pub. Date: Jan. 8, 2009

(54) NOVEL POLYMERIZABLE SURFACE ACTIVE MONOMERS WITH BOTH FLUORINE-CONTAINING GROUPS AND HYDROPHILIC GROUPS

(76) Inventors: Yu-Chin Lai, Pittsford, NY (US); Weihong Lang, Amston, CT (US)

Correspondence Address: Glenn D. Smith;Bausch & Lomb Incorporated, One Bausch & Lomb Place, Rochester, NY, 14604, US

(21) Appl. No.: 11/772,936

(22) Filed: Jul. 3, 2007

(51) Int. Cl. G02C 7/04; C08F 16/24

(52) U.S. Cl. 526/244; 526/245

(57) ABSTRACT

Provided are surface modified contact lenses formed from one or more fumaric- or itaconic-containing prepolymers having polymerizable functionality that is complimentary to polymerizable hydrophilic polymers.

### CROSS-REFERENCE TO RELATED APPLICATIONS

None

### FIELD OF THE INVENTION

The present invention relates generally to polymerizable fumaric-, maleic- and itaconic-containing fluorinated prepolymers and compositions comprising the prepolymers used in the manufacture of medical devices. More specifically, the present invention relates to contact lenses formed from one or more fluorinated fumaric-, maleic- or itaconic-containing prepolymers.

### BACKGROUND OF THE INVENTION

Medical devices such as ophthalmic lenses made from silicone materials have been investigated for a number of years. Such materials can generally be sub-divided into two major classes, namely hydrogels and non-hydrogels. Non-hydrogels do not absorb appreciable amounts of water, whereas hydrogels can absorb and retain water in an equilibrium state. Hydrogels generally have water content between about 15 to about 80 weight percent. Regardless of their water content, both non-hydrogel and hydrogel silicone medical devices tend to have relatively hydrophobic, non-wettable surfaces that have a high affinity for lipids. This problem is of particular concern with contact lenses.

Fumarate- and fumaramide-containing monomers and compositions comprising the monomers have been developed to make highly oxygen permeable hydrogels which may be used to make biomedical devices including contact lenses. Examples of these fumarate- and fumaramide-containing monomers and compositions can be found in U.S. Pat. Nos. 5,374,662, 5,420,324, and 5,496,871, the contents of each being incorporated by reference herein. Because of the polar character of amide functionality, this class of monomer shows good compatibility with both hydrophobic monomers such as tris(trimethylsiloxy)silane (TRIS) and hydrophilic monomers such as N,N-dimethylacrylamide (DMA). These prior art prepolymers provide silicone hydrogels with excellent oxygen permeability and mechanical properties. However, like other silicone hydrogels, they are not wettable enough to be useful as continuous wear lenses unless the surface is treated.

Surface structure and composition determine many of the physical properties and ultimate uses of solid materials. Characteristics such as wettability and lipid deposit resistance are largely influenced by surface characteristics. The alteration of surface characteristics is of special significance in biotechnical applications where biocompatibility is of particular concern. Therefore, those skilled in the art have long recognized the need for rendering the surface of contact lenses and other medical devices hydrophilic or more hydrophilic. Increasing the hydrophilicity of the contact-lens surface improves the wettability of the contact lenses with tear fluid in the eye. This in turn improves the wear comfort of the contact lenses. In the case of continuous-wear lenses, the surface is especially important. The surface of a continuous-wear lens must be designed not only for comfort, but to avoid adverse reactions such as corneal edema, inflammation, or lymphocyte infiltration. Improved surface active monomers have accordingly been sought for preparing contact lenses having improved surface properties.

It is well known in rigid gas permeable lenses (RGP's) that the presence of fluorine-containing monomers such as octafluoropentyl methacrylate (OFPMA), hexafluoroisopropyl methacrylate (HFIPMA), and bi-hexafluoroisopropyl itaconate (BHI) in the formulation from which RGP's are derived can help improve lipid and protein deposit resistance. It is also known in RGP's and silicone hydrogel contact lenses that acid-containing monomers can help the surface wettability of a lens.

Although surface active prepolymers such as methacrylate-capped copolymers of fluorine-containing monomer and PEO-based monomer are well known, until now there is no monomer which contains both a fluorine-containing group and hydrophilic-containing group. This type of monomer should provide both surface wettability as well as lipid deposit resistance to a contact lens. More importantly, because of its surface-active nature, it could potentially make the wetting characteristics of the hydrophilic group more effective.

### SUMMARY OF THE INVENTION

In this invention, polymerizable fluorinated monomers such as those described above are disclosed. These monomers can be polymerizable fumarate/fumaramide, maleate/maleic amide or itaconate/itaconamide groups containing a fluorine-containing group and an acid or other hydrophilic group/oligomers. Namely, they have one of the following three structures:

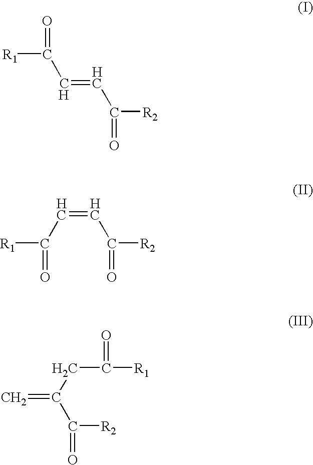

wherein R₁ is O—Rf or NH—Rf, Rf is an alkyl group of 4 to 20 carbon atoms containing fluorine atoms; and R₂ is OH, acid containing group or a derivative of a hydrophilic oligomer. The hydrophilic oligomer can be those derived from hydrophilic monomers such as N-Vinyl pyrrolidinone (NVP), N,N-dimethylacrylamide (DMA), Glycerol methacrylate (GMA), etc.

The monomers of the invention herein can be prepared using either the commercially available acid chloride or anhydride as the starting compound and reacting the starting material first with a fluorine-containing alcohol then reacting with water or hydroxyl or amino-containing polymerizable hydrophilic oligomer. The final monomer can be a single compound or a mixture of compounds, depending on the polymerizable hydrophilic oligomers used or reactants (acid chloride or anhydride) used in the synthetic procedure.

The invention is further directed toward medical devices formed of a polymerizable mix comprising the polymerizable fumaric-, maleic- and itaconic-containing fluorinated prepolymers. Such devices are useful in forming surface modified medical devices without the use of surface treatments such as plasma treatment or corona discharge treatment.

Provided herein are novel polymerizable surface active monomers with both fluorine-containing groups and hydrophilic groups. The monomers have the structure of formulae (I), (II) and (III) below:

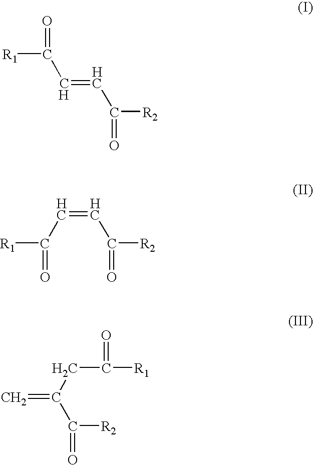

wherein R₁ is O—Rf or NH—Rf, Rf is an alkyl group of 4 to 20 carbon atoms containing fluorine atoms; and R₂ is OH, acid containing group or a derivative of a hydrophilic oligomer.

Also provided are polymerized monomer mixtures of formulae (I), (II) and (III) and devices comprising polymerized monomer mixtures comprising monomers of formulae (I), (II) and (III).

Also provided is a surface modified medical device comprising a medical device manufactured from a monomer mixture containing a polymerizable functionalized fumaric- or itaconic-containing fluorinated prepolymer and one or more polymerizable, hydrophilic polymers.

### BRIEF DESCRIPTION OF THE DRAWINGS

None

### DETAILED DESCRIPTION OF THE INVENTION

As stated above, the present invention is directed toward polymerizable fumaric-, maleic- and itaconic-containing fluorinated prepolymers for use with copolymerizable polymeric systems used for biomedical devices, especially contact lenses. As used herein, fumaric refers to a derivative of fumaric acid and can be a fumarate (an ester), a fumaramide (an amide) or a residue having both ester and amide functionalities. The fumaric group is a residue of trans-1,2-ethylenedicarboxylate. Therefore, it will be understood that the diastereoisomer of fumarate, maleate, is also intended to be included in the fumaric-containing prepolymers of the present invention. Itaconic refers to derivatives of itaconic acid and has a similar meaning as that of fumaric. In further embodiments of the present invention, the prepolymers are used to make biomedical devices and are useful in contact lens formulations which may be either “soft” or “hard” and which may preferably be hydrogels.

The polymerizable fumaric-, maleic- and itaconic-containing fluorinated prepolymers of the present invention have at least one fumaric, maleic or itaconic group. Monomer mixes comprising the prepolymers of the present invention may comprise both thermal- and photoinitiators for curing purposes. The monomer mixes may further comprise at least one additional hydrophilic monomer. Further, the monomer mix may additionally comprise at least one silicone monomer.

As is known in the field, certain crosslinked polymeric materials may be polymerized to form a hard, water-free, xerogel. Xerogels are understood to be unhydrated hydrogel formulations. It was found that such xerogels could be physically altered to, for example, impart optical properties through machining, and then be hydrated and retain their water content.

When the term “polymerization” or “polymerizable” is used herein we refer to the polymerization of the double bonds or acrylic group of the monomers and prepolymers with polymerizable unsaturated groups which results in a crosslinked three-dimensional network.

Further, notations such as “(meth)acrylate” or “(meth)acrylamide” are used herein to denote optional methyl substitution. Thus, for example, (meth)acrylate includes both acrylate and methacrylate and N-alkyl-(meth)acrylamide includes both N-alkyl acrylamide and N-alkyl methacrylamide.

The term “prepolymer” denotes a high molecular weight monomer containing polymerizable groups. The monomers added to the monomeric mixture of the present invention may therefore be low molecular weight monomers or prepolymers. Thus, it is understood that a term such as “silicone monomers” includes “silicone prepolymers” as well as “silicone macromers”.

The terms “shaped articles for use in biomedical applications” or “biomedical devices or materials” or “biocompatible materials” mean the hydrogel materials disclosed herein have physicochemical properties rendering them suitable for prolonged contact with living tissue, blood and the mucous membranes.

While the present invention contemplates the use of polymerizable fumaric-, maleic- and itaconic-containing fluorinated prepolymers for medical devices including both “hard” and “soft” contact lenses, the formulations containing the polymerizable fumaric-, maleic- and itaconic-containing fluorinated prepolymers of the present invention are thought to be especially useful as soft hydrogel contact lenses. As is understood in the field, a lens is considered to be “soft” if it can be folded back upon itself without breaking.

A hydrogel is a hydrated cross-linked polymeric system that contains water in an equilibrium state. Silicone hydrogels (i.e., hydrogels containing —OSi— linkages) are usually prepared by polymerizing a mixture containing at least one silicone monomer and at least one hydrophilic monomer. By the term silicone, it is meant that the material is an organic polymer comprising at least five percent by weight silicone, preferably 10 to 100 percent by weight silicone, more preferably 30 to 90 percent by weight silicone. Applicable silicone monomeric units for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Provided herein are novel polymerizable fumaric-, maleic- and itaconic-containing fluorinated prepolymers. The monomers have the structure of formulae (I), (II) and (III) below:

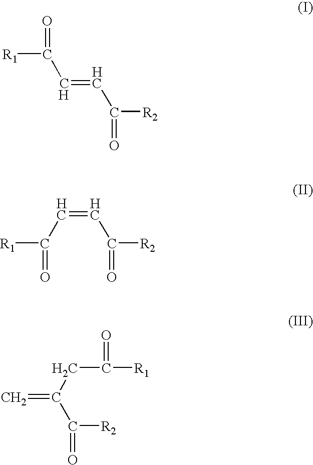

wherein R₁ is O—Rf or NH—Rf, Rf is an alkyl group of 4 to 20 carbon atoms containing fluorine atoms; and R₂ is OH, acid containing group or a derivative of a hydrophilic oligomer.

The polymerizable fumaric-, maleic- and itaconic-containing fluorinated prepolymers of the present invention have at least one fumaric, maleic or itaconic group.

Also provided are polymerized monomer mixtures of formulae (I), (II) and (III) and devices comprising polymerized monomer mixtures comprising monomers of formulae (I), (II) and (III).

Monomer mixes comprising the prepolymers of the present invention may comprise at least one additional hydrophilic monomer. The monomer mixes may further comprise at least one silicone monomer. Further, the monomer mix may additionally comprise both thermal- and photoinitiators for curing purposes.

The polymerizable fumaric-, maleic- and itaconic-containing fluorinated prepolymers of the present invention (i.e., polymerizable surface active monomers) are prepared according to syntheses well known in the art and according to the examples disclosed herein. The polymerizable fumaric-, maleic- and itaconic-containing fluorinated prepolymers of the present invention are incorporated into the monomer mix. The relative weight % of the polymerizable fumaric-, maleic- and itaconic-containing fluorinated prepolymers as compared to the total monomer mix weight % is from about 0.25% to 10%, more preferably from about 0.5% to 5%, and most preferably 1% to 2%.

Examples of hydrophilic monomers include, but are not limited to, ethylenically unsaturated lactam-containing monomers such as N-vinyl pyrrolidinone; methacrylic and acrylic acids; (meth)acrylic substituted alcohols, such as 2-hydroxyethylmethacrylate (HEMA) and 2-hydroxyethylacrylate; and (meth)acrylamides, such as methacrylamide and N,N-dimethylacrylamide (DMA); vinyl carbonate or vinyl carbamate monomers such as disclosed in U.S. Pat. No. 5,070,215; and oxazolinone monomers such as disclosed in U.S. Pat. No. 4,910,277. Other hydrophilic monomers such as glycerol methacrylate and polyethyleneglycol monomethacrylate are also useful in the present invention.

Preferred hydrophilic vinyl-containing monomers that may be incorporated into the hydrogels of the present invention include monomers such as N-vinyl lactams such as N-vinyl pyrrolidinone (NVP), N-vinyl-N-methyl acetamide, N-vinyl-N-ethyl acetamide, N-vinyl-N-ethyl formamide, N-vinyl formamide, with NVP being the most preferred.

Preferred hydrophilic acrylic-containing monomers which may be incorporated into the hydrogel of the present invention include hydrophilic monomers such as N,N-dimethyl acrylamide (DMA), 2-hydroxyethyl methacrylate, glycerol methacrylate, 2-hydroxyethyl methacrylamide, methacrylic acid and acrylic acid, with DMA being the most preferred. Other suitable hydrophilic monomers will be apparent to one skilled in the art. The relative weight % of hydrophilic monomer(s) to total weight % of the comonomer mix is preferably from about 5% to 80%, more preferably from about 20% to 70%, and most preferably 20% to 40%.

As mentioned previously, additional silicone monomers may be present in the monomer mixes with the polymerizable fumaric-, maleic or itaconic-containing fluorinated prepolymers of the present invention. One preferred class of suitable silicone monomers which may be incorporated into a monomer mix with the polymerizable fumaric-, maleic- or itaconic-containing fluorinated prepolymers of the present invention are the bulky polysiloxanylalkyl(meth)acrylic monomers represented by the following Formula (IV):

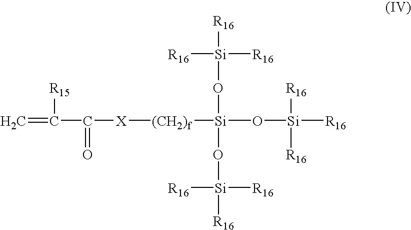

wherein: X is O or NR; R is an alkyl group having 1 to 5 carbon atoms; each R₁₅ is independently hydrogen or an alkyl group having 1 to 10 carbon atoms; each R₁₆ is independently a lower alkyl having 1 to 5 carbon atoms or a phenyl group; and f is 1 or 3 to 10.

Such bulky monomers include methacryloxypropyl tris(trimethylsiloxy)silane (TRIS), pentamethyldisiloxanylmethylmethacrylate, tris(trimethylsiloxy)methacryloxy propylsilane, phenyltetramethyldisiloxanylethyl acrylate, and methylbis(trimethylsiloxy)methacryloxymethyl silane. Further preferred classes of silicone monomers which may be incorporated into a monomer mix with the polymerizable fumaric-, maleic- or itaconic-containing fluorinated monomers of the present invention are the poly(organosiloxane) monomers represented by the following formula (V):

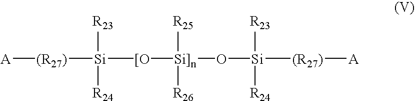

wherein: A is an activated unsaturated group, such as an ester or amide of an acrylic or a methacrylic acid; each R₂₃-R₂₆ is independently selected from the group consisting of a monovalent hydrocarbon radical or a halogen substituted monovalent hydrocarbon radical having 1 to 18 carbon atoms which may have ether linkages between carbon atoms; R₂₇ is a divalent hydrocarbon radical having from 1 to 22 carbon atoms and may contain ether or thio linkage; and n is 0 or an integer greater than or equal to 1. When siloxane-containing monomers other than the bulky silicone prepolymers are incorporated into the monomer mix, the weight % of the other siloxane-containing monomers as compared to the total monomer mix weight % is from about 1% to 60%, more preferably from about 3% to 50%, and most preferably 5% to 40%.

Either the silicone monomer, the polymerizable fumaric-, maleic- or itaconic-containing fluorinated prepolymer, or the hydrophilic monomer may function as a crosslinking agent (a crosslinker), being defined as a monomer having multiple polymerizable functionalities. Additional crosslinkers also may be present in the monomer mix which polymerizes to form the hydrogel.

Most “known” crosslinking agents are hydrophobic. When it is desirable for both an acrylic-containing monomer and a vinyl-containing monomer to be incorporated into the silicone polymer of the present invention, a further crosslinking agent having both a vinyl and an acrylic polymerizable group may be used, since these vinyl and acrylic monomers have differing reactivity ratios and may not copolymerize efficiently. Such crosslinkers which facilitate the copolymerization of these monomers are the subject of U.S. Pat. No. 5,310,779, the content of which is incorporated herein by reference. Such crosslinkers are represented by the following schematic representation:

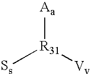

wherein V denotes a vinyl-containing group having the formula:

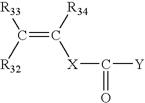

A denotes an acrylic-containing group having the formula:

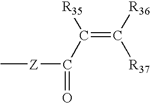

and S denotes a styrene-containing group having the formula:

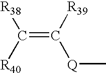

wherein R₃₁ is an alkyl radical derived from substituted and unsubstituted hydrocarbons, polyalkylene oxide, poly(perfluoro)alkylene oxide, dialkyl-capped polydimethylsiloxane, dialkyl-capped polydimethylsiloxane modified with fluoroalkyl or fluoroether groups; R₃₂-R₄₀ are independently H, or alkyl of 1 to 5 carbon atoms; Q is an organic group containing aromatic moieties having 6-30 carbon atoms; X, Y, and Z are independently O, NH or S; v is 1, or higher; and a and s are independently greater than or equal to 0; and a+s is greater than or equal to 1. An example is 2-hydroxyethylmethacrylate vinyl carbonate or carbamate.

Other crosslinking agents which may be incorporated into the silicone hydrogel of the present invention include polyvinyl, typically di- or tri-vinyl monomers, most commonly the di- or tri(meth)acrylates of dihydric ethylene glycol, triethylene glycol, butylene glycol, hexane-1,6-diol, thio-diethylene glycol-diacrylate and methacrylate; neopentyl glycol diacrylate; trimethylolpropane triacrylate and the like; N,N′-dihydroxyethylene-bisacrylamide and -bismethacrylamides; also diallyl compounds like diallyl phthalate and triallyl cyanurate; divinylbenzene; ethylene glycol divinyl ether; and the (meth)acrylate esters of polyols such as triethanolamine, glycerol, pentaerythritol, butylene glycol, mannitol, and sorbitol. Further examples include N,N-methylene-bis-(meth)acrylamide, sulfonated divinylbenzene, and divinylsulfone. Also useful are the reaction products of hydroxyalkyl(meth)acrylates with unsaturated isocyanates, for example the reaction product of 2-hydroxyethyl methacrylate with 2-isocyanatoethyl methacrylate (IEM). See U.S. Pat. No. 4,954,587.

Other known crosslinking agents are polyether-bisurethane-dimethacrylates (see U.S. Pat. No. 4,192,827), and those crosslinkers obtained by reaction of polyethylene glycol, polypropylene glycol and polytetramethylene glycol with 2-isocyanatoethyl methacrylate (IEM) or m-isopropenyl-γ,γ-dimethylbenzyl isocyanates (m-TMI), and polysiloxane-bisurethane-dimethacrylates. See U.S. Pat. Nos. 4,486,577 and 4,605,712. Still other known crosslinking agents are the reaction products of polyvinyl alcohol, ethoxylated polyvinyl alcohol or of polyvinyl alcohol-co-ethylene with 0.1 to 10 mol % vinyl isocyanates like IEM or m-TMI.

The prepolymers of the present invention, when copolymerized, are readily cured to cast shapes by methods such as UV polymerization, use of free radical thermal initiators and heat, or combinations thereof. Representative free radical thermal polymerization initiators are organic peroxides, such as for example acetyl peroxide, lauroyl peroxide, decanoyl peroxide, stearoyl peroxide, benzoyl peroxide, tertiary butyl peroxypivalate, peroxydicarbonate, and the commercially available thermal initiators such as LUPERSOL® 256, 225 (Atofina Chemical, Philadelphia, Pa.) and the like, employed in a concentration of about 0.01 to 2 percent by weight of the total monomer mixture. Representative UV initiators are those known in the field such as, benzoin methyl ether, benzoin ethyl ether, DAROCUR®-1173, 1164, 2273, 1116, 2959, 3331, IGRACURE® 651 and 184 (Ciba Specialty Chemicals, Ardsley, N.Y.).

In addition to the above-mentioned polymerization initiators, the copolymer of the present invention may also include other components as will be apparent to one skilled in the art. For example, the monomer mix may include additional colorants, or UV-absorbing agents and toughening agents such as those known in the contact lens art.

The resulting copolymers of this invention can be formed into contact lenses by the spincasting processes such as those disclosed in U.S. Pat. Nos. 3,408,429 and 3,496,254, static casting processes such as in U.S. Pat. No. 5,271,875 and other conventional methods, such as compression molding as disclosed in U.S. Pat. Nos. 4,084,459 and 4,197,266.

Polymerization of the monomer mix may be conducted either in a spinning mold, or a stationary mold corresponding to a desired contact lens shape. The thus-obtained contact lens may be further subjected to a mechanical finishing, as occasion demands. Also, the polymerization may be conducted in an appropriate mold or vessel to give a lens material in the form of button, plate or rod, which may then be processed (e.g., cut or polished via lathe or laser) to give a contact lens having a desired shape.

In certain embodiments, the hydrogels produced by the present invention are oxygen permeable, hydrolytically stable, biologically inert, and transparent. The monomers and prepolymers employed in accordance with this invention are readily polymerized to form three-dimensional networks which permit the transport of oxygen and, in certain embodiments, are optically clear, strong and hydrophilic.

The present invention provides materials which can be usefully employed for the fabrication of prostheses such as heart valves and intraocular lenses, as optical contact lenses or as films. More particularly, the present invention concerns contact lenses.

The present invention further provides articles of manufacture which can be used for biomedical devices, such as, surgical devices, heart valves, vessel substitutes, intrauterine devices, membranes and other films, diaphragms, surgical implants, blood vessels, artificial ureters, artificial breast tissue and membranes intended to come into contact with body fluid outside of the body, e.g., membranes for kidney dialysis and heart/lung machines and the like, catheters, mouth guards, denture liners, intraocular devices and especially contact lenses.

It is known that blood, for example, is readily and rapidly damaged when it comes into contact with artificial surfaces. The design of a synthetic surface which is antithrombogenic and nonhemolytic to blood is necessary for prostheses and devices used with blood.

Although the teachings of the present invention are preferably applied to soft or foldable contact lenses or like medical devices formed of a foldable or compressible material, the same may also be applied to harder, less flexible, lenses formed of a relatively rigid material such as poly(methyl methacrylate) (PMMA).

The polymerizable fumaric-, maleic- and itaconic-containing fluorinated prepolymers useful in certain embodiments of the present invention may be prepared according to syntheses well known in the art and according to the methods disclosed in the following examples.

### EXAMPLES

### Example 1

### Preparation of Itaconic Acid, Mono Pentafluoropentyl Ester

To a thoroughly dried 250-mL, 3-neck round bottom flask equipped with nitrogen inlet tube and drying tube was charged 6.555 g (55.557 mmol) itaconic anhydride, 40 ml anhydrous acetonitrile, 15 ml anhydrous methylene chloride and 9.860 g (54.810 mmol) 4,4,5,5,5-pentafluoro-1-pentanol through syringes. Then 10 drops of concentrated sulfuric acid was added. The contents were refluxed and stirred. Samples were taken out periodically for GC analyses. After 4 days, the solvent was stripped to give 13.308 g while solid. After column chromatography, 6.70 grams of purified product was recovered.

NMR: ¹H⁰: 1.858 ppm, quintuplet; 1.938 ppm, multiplet; 2.084 ppm, multiplet; 3.344 ppm, singlet; 3.769, multiplet 4.176 ppm, triplet; 5.831 ppm, singlet; 6.461 ppm, singlet; 11.650 ppm, broad.

¹³C⁰: 20.246 ppm, singlet; 25.768 ppm, singlet; 27.696 ppm, triplet; 37.483 ppm, singlet; 63.606 ppm, singlet; 68.096 ppm, singlet; 115.681 ppm, singlet; 116.049 ppm, singlet; 131.136 ppm, singlet; 133.359 ppm, singlet; 170.621 ppm, singlet; 171.642 ppm, singlet.

GC MS: predominant peak at 6.3 minute, M+=290, fragments confirm the structure, 161, 130, 113, 85, 47

ESI MS: M/Na+=313.01

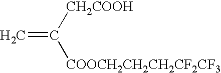

### Example 2

### Preparation of Mercaptoethanol Functionalized Oligo (NVP)

A thoroughly dried 1000-mL round bottom flask equipped with a reflux condenser and nitrogen inlet was charged with N-vinylpyrrolidone (155 g, 1.395 mole), 2-mercaptoethanol (24 mL or 0.342 mole) and 350 mL anhydrous tetrahydrofuran. The contents, while stirred at room temperature, were bubbled with nitrogen for about 15 minutes then Vazo 64 (2.17 gram) was added and dissolved. The contents were then heated to reflux for 48 hours. The solution was then condensed to 250 mL and then poured into 2500 mL of diethyl ether to precipitate a white product. The recovered product was purified by dissolution/precipitation in methylene chloride/ether. The final product was a white powder which after vacuum drying weighed 131.68 grams. NMR and SEC characterizations proved the formation of functionalized oligo (NVP).

The molecular weight of the oligomer product was determined by acid-base titration. The oligomer product was first allowed to react with an excess amount of phenyl isocyanate, then with an excess amount of dibutylamine, both in THF, followed by titrating with standardized 0.1 N hydrochloric acid. The molecular weight as determined was 416. (Theoretical 623)

NMR: ¹H⁰: from 1.2 ppm to 2.4 ppm, 5 broad peaks; 2.622 ppm, triplet; 2.662 ppm, triplet; 3.190 ppm, broad; 3.341 ppm, triplet; 3.420 ppm, triplet; 3.647 ppm, triplet; 3.820 ppm, broad.

¹³C⁰: 17.811 ppm; 18.141 ppm, broad; 29.700; 30.724 ppm; 31.339 ppm, broad; 35.312 ppm, 42.101 ppm; 47.240 ppm; 60.833 ppm; 175.180 ppm, broad; 175.384 ppm.

SEC: Mn=913

MALDI-TOF MS: predominant series of 1987.60 with repeat unit of 111.14

### Example 3

### Preparation of Itaconate Monomer with Both Pentylfluoropentyl Ester and Oligomeric NVP Group

Into an oven-dried 250 ml round bottom flask containing 20 ml anhydrous methylene chloride was added 6.204 g (21.380 mmol) of itaconic acid pentylfluoropentyl monomer ester of Example 1 and a clear solution of 4.444 g (21.538 mmol) N,N′-Dicyclohexylcarbodiimide (DCC) in 25 ml anhydrous methylene chloride under stirring. White precipitate appeared within minutes of addition of DCC. A solution of dried mercaptoethanol-capped oligomer NVP (12.563 g, 22.474 mmol) in 75 ml anhydrous methylene chloride was then prepared and added into the round bottom flask with itaconate. The mixture was stirred under nitrogen for a week. The reaction mixture was then filtered to give a clear yellow solution. The solvent was then removed using a rotavapor to give 20.553 g of a pale yellow solid.

The product can be column purified. The formation of the desired modified oligo (NVP) was proven by NMR and MALDI-TOF MS.

NMR: ¹H⁰: from 1.0 ppm to 2.4 ppm, broad overlapped multiple peaks; 2.714 ppm, triplet; 2.807 ppm, triplet; 3.0 ppm to 3.36 ppm, broad overlapped peaks; 3.416 ppm, triplet; 3.473 ppm, triplet; 3.6 to 4.0 ppm, broad peaks; 4.165 ppm, triplet; 4.294 ppm, triplet; 5.352 ppm, singlet; 5.669 ppm, singlet; 5.827 ppm, singlet; 6.336 ppm, singlet.

¹³C⁰: 18.274 ppm; 18.558 ppm; 20.323 ppm; 24.899 ppm; 26.311 ppm; 27.757 ppm; 29.958 ppm; 30.315 ppm; 30.645 ppm; 31.032 ppm; 32.087 ppm; 37.863 ppm; 42.075 ppm; 47.714 ppm; 55.031 ppm; 63.375 ppm; 63.527 ppm; 64.017 ppm; 120.890 ppm; 129.083 ppm; 133.534 ppm; 165.859 ppm; 167.927 ppm; 170.447 ppm; 175.304 ppm.

MALDI-TOF MS: A mercaptoethanol functionalized PVP had series of 1989.12 and 1965.57 both with repeat unit of 111.14, product has new series appeared at 1820.13 with repeat unit of 111.14, together with 1986.74 and 1964.78 both with repeat unit of 111.14.

### Example 4

### Preparation of Mercaptoethanol Functionalized Oligo (DMA)

A thoroughly dried 1000-mL round bottom flask equipped with a reflux condenser and Nitrogen inlet was charged with N,N-dimethylacrylamide (140.05 g, mole), 2 mercaptoethanol (19.8 mL or 0.1796 mole), 450 mL anhydrous tetrahydrofuran and Vazo 64 (1.14 gram). The contents, while stirred at room temperature, were bubbled with nitrogen for about 15 minutes. The contents were then heated to reflux for 48 hours. IR indicated no vinyl groups present. The solution was then condensed to 120 mL and then poured into 1200 mL of ether to precipitate the product. The dissolution/precipitation was repeated twice. The final product was a white powder. The molecular weight of the oligomer product was determined by acid-base titration. It was first allowed to react with an excess amount of isophorone diisocyanate overnight in dichloromethane, then, some of product was taken out and added with excess amount of dibutylamine in THF followed by titrating with standardized 0.1 N hydrochloric acid. The molecular weight as determined was 731.

### Example 5

### Preparation of Itaconate Monomer with Both Pentylfluoropentyl Ester and Oligomeric DMA Group

This monomer is prepared by following the procedure as described in Example 3 except that mercaptoethanol-capped oligomeric DMA is used instead of mercaptoethanol-capped oligomeric NVP.

### Example 6

### Monomer Mix for Lens Casting

A monomer mix derived from components listed in the following table is prepared.

| | Parts by Weight |
|---|---|
| F₂D₂₀ | 20 |
| TRIS | 40 |
| DMA | 40 |
| n-hexanol | 5 |
| Darocur initiator | 0.5 |
| Tint Agent | 150 ppm |

The following materials are designated above:

TRIS tris(trimethylsiloxy)silylpropyl methacrylate

DMA N,N-dimethylacrylamide

F2D20 a silicone-containing crosslinking resin as previously described in U.S. Pat. Nos. 5,374,662 and 5,496,871.

### Example 7

### Monomer Mix with NVP Oligomer-Terminated Fumarate Prepolymer of Polytetrafluoroethylene Glycol

A monomer mix containing the above components at the same parts as those listed in Table 1 is mixed with 0.5 part of itaconate monomer with both pentylfluoropentyl ester and oligomeric NVP group is used.

### Example 8

### Lens Casting

The monomer mixture of Examples 6 and 7 are injected onto separate clean polypropylene anterior mold halves and covered with the complementary polypropylene anterior mold half. The mold halves are compressed and the mixtures are cured by exposure to UV radiation for 60 minutes. The top mold half is removed and the lenses are maintained in a forced air oven to remove the majority of the n-hexanol diluent. The lenses are removed from the bottom mold half, extracted in isopropanol, and then hydrated in distilled water. They are then placed in borate buffered saline and autoclaved.

### Example 9

### Lens Surface Wettability

Lenses of Examples 7 and 8 are compared visually for surface wettability. It is found that lenses cast with the presence of itaconate monomer with both pentylfluoropentyl and oligomeric NVP group show much better wettability as compared to those without.

### Example 10

### Surface Characterization of Lenses by XPS

Lenses from Example 7 and 8 are desalinated in polystyrene Petri dish containing HPLC grade water for approximately 15 minutes to remove excess borate saline solution. They are then quartered with a clean scalpel and set up on clean sample platens. Three lenses, posterior and anterior, are analyzed per sample. XPS data is collected at Bausch & Lomb's Surface Science laboratory using a Physics Electronics Quantum 2000 Scanning ESCA Microscope for surface characterization. The surface element content (C, N, Si, F) are quantified for each group of lenses. It is found that while the element content from lenses cast in Example 7 is rich in Si, the element contents of Example 8 indicate that the lens surface can be changed significantly by incorporating itaconate monomer with both pentylfluoropentyl and oligomeric NVP group into a silicone hydrogel contact lens formulation.

Contact lenses manufactured using the unique materials of the present invention are used as customary in the field of ophthalmology. While there is shown and described herein certain specific structures and compositions of the present invention, it will be manifest to those skilled in the art that various modifications may be made without departing from the spirit and scope of the underlying inventive concept and that the same is not limited to particular structures herein shown and described except insofar as indicated by the scope of the appended claims.

What is claimed is:

1. A polymerizable surface active monomer selected form the group consisting of monomers having the structure of formulae (I), (II) and (III) below: 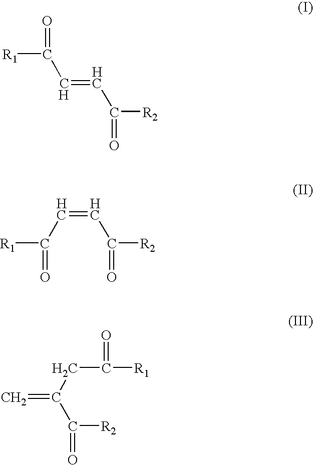
wherein R₁ is O—Rf or NH—Rf, Rf is an alkyl group of 4 to 20 carbon atoms containing fluorine atoms, and R₂ is OH, acid containing group, or a derivative of a hydrophilic oligomer.

2. The polymerizable monomer of claim 1 wherein the monomer has the following formula:

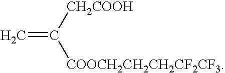

3. A polymerizable monomer mixture comprising at least one monomer of claim 1.

4. The polymerizable monomer mixture of claim 3 wherein the relative weight % of the polymerizable surface active monomer as compared to the total monomer mix weight % is from about 0.25% to about 10%

5. The polymerizable monomer mixture of claim 3 wherein the relative weight % of the polymerizable surface active monomer as compared to the total monomer mix weight % is about 0.5% to about 5%.

6. The polymerizable monomer mixture of claim 3 wherein the relative weight % of the polymerizable surface active monomer as compared to the total monomer mix weight % is about 1% to about 2%.

7. The monomer mixture of claim 3 further comprising at least one additional hydrophilic monomer.

8. The monomer mixture of claim 7 wherein the hydrophilic monomer is selected from the group consisting of ethylenically unsaturated lactam-containing monomers, methacrylic acids, acrylic acids, (meth)acrylic substituted alcohols, (meth)acrylamides, vinyl carbonate, vinyl carbamate monomers, oxazolinone monomers, glycerol methacrylate, polyethyleneglycol monomethacrylate and mixtures thereof.

9. The monomer mixture of claim 3 further comprising at least one silicone monomer.

10. The monomer mixture of claim 9 wherein the at least one silicone monomer is a bulky polysiloxanylalkyl(meth)acrylic monomer.

11. The monomer mixture of claim 9 further wherein the at least one silicone monomer is selected from the group consisting of methacryloxypropyl tris(trimethylsiloxy)silane (TRIS), pentamethyldisiloxanylmethylmethacrylate, tris(trimethylsiloxy)methacryloxy propylsilane, phenyltetramethyldisiloxanylethyl acrylate, methylbis(trimethylsiloxy)methacryloxymethyl silane and mixtures thereof.

12. The monomer mixture of claim 3 further comprising a crosslinking agent.

13. A surface modified medical device comprising a medical device manufactured from a monomer having the structure of formulae (I), (II) and (III) below: 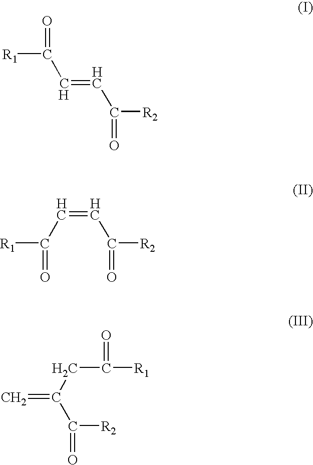
wherein R₁ is O—Rf or NH—Rf, Rf is an alkyl group of 4 to 20 carbon atoms containing fluorine atoms, and R₂ is OH, acid containing group or a derivative of a hydrophilic oligomer; and one or more polymerizable, hydrophilic polymers.

14. The medical device of claim 13 wherein the medical device has at least one of the property selected from the group consisting of oxygen permeable, hydrolytically stable, biologically inert, and transparent.

15. The medical device of claim 13 wherein the medical device is polymerized to form three-dimensional networks which permit the transport of oxygen.

16. The medical device of claim 13 wherein the medical device is polymerized to form an optically clear, strong and hydrophilic medical device.

17. The medical device of claim 16 wherein the medical device is an ophthalmic lens.

18. The medical device of claim 17 wherein the medical device is a contact lens.

19. The medical device of claim 17 wherein the medical device is an intraocular lens.
